(19) United States
(12) Patent Application Publication
(10) Pub. No.: US 2012/0121080 A1
(43) Pub. Date: May 17, 2012

(54) COMMUTATIVE ORDER-PRESERVING ENCRYPTION

(75) Inventor: Florian Kerschbaum, Karlsruhe (DE)

(73) Assignee: SAP AG, Walldorf (DE)

(21) Appl. No.: 12/944,672

(22) Filed: Nov. 11, 2010

(51) Int. Cl. H04L 9/28

(52) U.S. Cl. 380/28

(57) ABSTRACT

In one general aspect, a method, including executing instructions recorded on a non-transitory computer-readable storage media using at least one processor, includes encrypting data using a commutative order-preserving encryption scheme. The commutative order-preserving encryption scheme includes a unique fixed key and a regular keyed cryptographic hash function, where the cryptographic hash function includes a domain greater than the unique fixed key.

### TECHNICAL FIELD

This description relates to systems and techniques for commutative order-preserving encryption.

### BACKGROUND

During processing of data from different data sources, including streams of data from the data sources, concerns may arise over the privacy of the data. When the data sources are distributed, it is often desirable to encrypt the data. If the data sources use a shared key to encrypt the data, then a single party, who intentionally or accidentally leaks the shared key, may break the security of the system and compromise the privacy of the data from the data sources. Furthermore, it may be difficult to determine the party who leaked the key. Thus, it may be desirable to develop encryption systems and techniques to better protect the privacy of the data.

### SUMMARY

According to one general aspect, a method, including executing instructions recorded on a non-transitory computer-readable storage media using at least one processor, includes encrypting data using a commutative order-preserving encryption scheme.

Implementations may include one or more of the following features, either singly as individual features or in combination with other features. For example, the commutative order-preserving encryption scheme may include a unique fixed key and a regular keyed cryptographic hash function, where the cryptographic hash function comprises a domain greater than the unique fixed key. A bit length of the cryptographic hash function may be at least three times as long as a bit length of the data. The unique fixed key may be distributed in multiple portions among multiple parties. The unique fixed key may be distributed in multiple portions among multiple parties in a tree format from an event source to an event processing engine. The commutative order-preserving encryption scheme may be represented by an encryption function:

E(x)=ax+H(x)=ax+b

wherein

E(x) is the encryption function,

a is a unique fixed key,

H(x) is a regular keyed cryptographic hash function

x is plaintext, and

b is a random summand.

The method may further include using the commutative order-preserving encryption scheme as part of a blind encryption protocol.

In another general aspect, a recordable storage medium may have recorded and stored thereon instructions that, when executed, cause at least one processor to perform the action of encrypting data using a commutative order-preserving encryption scheme.

Implementations may include one or more of the following features, either singly as individual features or in combination with other features. For example, the commutative order-preserving encryption scheme may include a unique fixed key and a regular keyed cryptographic hash function, where the cryptographic hash function comprises a domain greater than the unique fixed key. A bit length of the cryptographic hash function may be at least three times as long as a bit length of the data. The unique fixed key may be distributed in multiple portions among multiple parties. The unique fixed key may be distributed in multiple portions among multiple parties in a tree format from an event source to an event processing engine. The commutative order-preserving encryption scheme may be represented by an encryption function:

E(x)=ax+H(x)=ax+b

wherein

E(x) is the encryption function,

a is a unique fixed key,

H(x) is a regular keyed cryptographic hash function

x is plaintext, and

b is a random summand.

The recordable storage medium may include further instructions that, when executed, cause the processor to perform the action of using the commutative order-preserving encryption scheme as part of a blind encryption protocol.

In another general aspect, a system for encrypting date includes a processor that is arranged and configured to encrypt data using a commutative order-preserving encryption scheme.

Implementations may include one or more of the following features, either singly as individual features or in combination with other features. For example, the commutative order-preserving encryption scheme may include a unique fixed key and a regular keyed cryptographic hash function, where the cryptographic hash function comprises a domain greater than the unique fixed key. A bit length of the cryptographic hash function may be at least three times as long as a bit length of the data. The unique fixed key may be distributed in multiple portions among multiple parties. The unique fixed key may be distributed in multiple portions among multiple parties in a tree format from an event source to an event processing engine. The commutative order-preserving encryption scheme may be represented by an encryption function:

E(x)=ax+H(x)=ax+b

wherein

E(x) is the encryption function,

a is a unique fixed key,

H(x) is a regular keyed cryptographic hash function

x is plaintext, and

b is a random summand.

The processor may be arranged and configured to use the commutative order-preserving encryption scheme as part of a blind encryption protocol.

The details of one or more implementations are set forth in the accompanying drawings and the description below. Other features will be apparent from the description and drawings, and from the claims.

### BRIEF DESCRIPTION OF THE DRAWINGS

FIG. 1 is an exemplary block diagram of a system for encrypting data.

FIG. 2 is an exemplary block diagram of a distributed system of event sources and a complex event processing (CEP) engine.

FIG. 3 is an exemplary flowchart illustrating a process for multiple event sources mapping to a same encryption key.

FIG. 4 is an exemplary flowchart illustrating a process for distributing key shares.

### DETAILED DESCRIPTION

This document describes systems and techniques for encrypting data. In one general aspect, data is encrypted using a commutative order-preserving encryption (COPE) scheme. In this manner, the commutative property of the encryption scheme means that the order of encryption does not matter. The order of encryption with different keys does not matter. Also, the COPE scheme allows the processing of inequality (e.g., greater-than, less-than, etc.) queries on cipher texts. The COPE scheme may be information-theoretically secure and the key of the COPE scheme may be information-theoretically secure even in the case, for instance, where an attacker on the encrypted data possesses a complete code book. The COPE scheme may be used for threshold encryption such that there is a key share for every possible distribution of keys.

As used herein, the terms “plain text”, “plain value” and “plain data” or simply the terms “text”, “value” and “data” mean an object, a message, a value or data that is not encrypted. The terms “cipher text”, “cipher value” and “encrypted data” mean an encrypted object such as an encrypted message, an encrypted value or data that has been encrypted.

In one exemplary implementation, a unique, fixed key a≧1 and a regular keyed, cryptographic hash function H(x) [symbol] y with domain 0≦y<a may be chosen. In one exemplary implementation, the hash function has k bits, a has k+1 bits (with the k-th significant bit always set) and k is much larger than the bit length of the plaintext. Let x be the plaintext in the encryption scheme and b be a random summand and E(x) is designated as the encryption function. Given plaintext x the encyrption may be computed as:

E(x)=ax+H(x)=ax+b (1)

Decryption may be performed as:

$$x = ⌊ \frac{E ( x )}{a} ⌋ \qquad ( 2 )$$

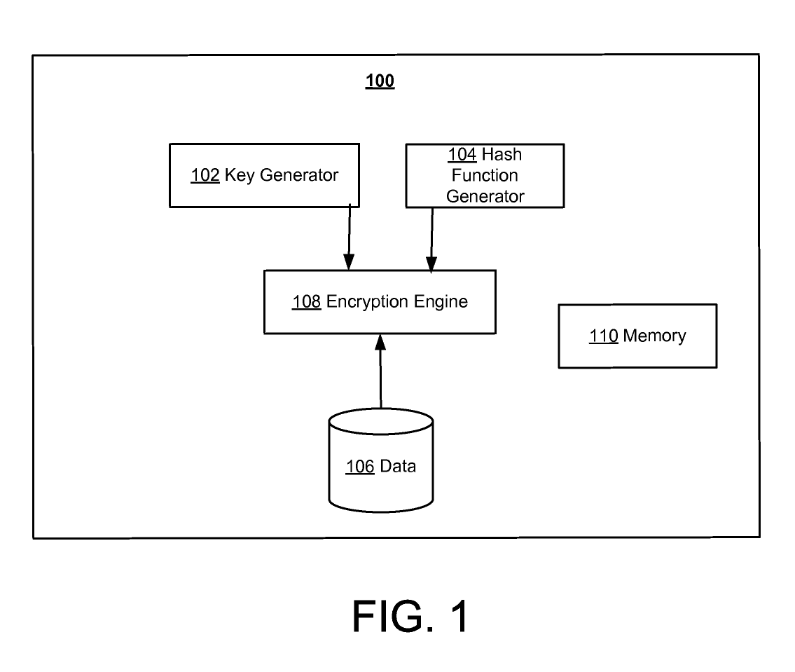

Referring to FIG. 1, an exemplary block diagram of an exemplary device 100 is illustrated. The device 100 may include a computing device such as, for example, a computer, a server, a workstation, a mobile or handheld computing device, a tablet device, a laptop, a smart phone, or any other type of computing device. The device 100 is an example of a device that may be used to encrypt plain text using the encryption scheme of Equation (1). The device 100 also may be used to decrypt cipher text using the decryption scheme of Equation (2).

The device 100 may include a key generator 102, a hash function generator 104, data storage 106, an encryption engine 108 and a memory 110. In one exemplary implementation, the key generator 102, the hash function generator 104 and the encryption engine 108 may be implemented as a processor or combination of processors that are configured to execute instructions stored in the memory 110, which cause these components to perform various functions or actions as described in more detail below. The key generator 102, the hash function generator 104 and the encryption engine 108 may be implemented on a same processor or on different processors or combination of processors. The key generator 102, the hash function generator 104, the data storage 106, the encryption engine 108 and the memory 110 may be operably coupled to each other.

The key generator 102 may be arranged and configured to generate the unique, fixed key a≧1. The hash function generator 104 may be arranged and configured to generate the cryptographic hash function H(x) [symbol] y . The key generator 102 may communicate the unique, fixed key to the encryption engine 108 and the hash function generator 104 may communicate the cryptographic hash function to the encryption engine 108. The data storage 106 may be configured to store data including, for instance, plain text that is to be encrypted by the encryption engine 108. In one exemplary implementation, the data storage 106 may include a table with a fixed or variable number of events in a database.

The encryption engine 108 may be arranged and configured to receive the unique, fixed key from the key generator 102 and the cryptographic hash function from the hash function generator 104 and to encrypt plain text received from the data storage 106 using the encryption scheme of Equation (1). In one exemplary implementation, the plain text is received from the data storage 106. In other exemplary implementations, the plain text may be received from other sources including, for example, other devices that may be the same as or similar to device 100, which are in communication with device 100 over a communications network. The encryption scheme of Equation (1) may generate cipher text, which may be stored in the data storage 106 or may be communicated to other devices that are similar to or the same as the device 100.

In one exemplary implementation, the encryption engine 108 may be configured to perform functions in addition to encrypting data. The encryption engine 108 may be arranged and configured to decrypt cipher text. For instance, the encryption engine 108 may be configured to decrypt cipher text according the decryption scheme of Equation (2) in order to reveal the plain text. In other exemplary implementations, the decryption of the cipher text may not be needed or desirable.

Also, the encryption engine 108 may be configured to perform processing related to manipulating multiple cipher texts. For instance, the encryption engine 108 may be configured to perform comparisons between multiple cipher text including, for example, equality and inequality comparisons between cipher texts.

In other exemplary implementations, the encryption engine 108 may be configured to perform complex event processing (CEP) or continuous data stream processing. Continuous stream processing may include the processing of a continuous stream of append-only tuples, which also may be referred to as events. For example, the encryption engine 108 may be configured to query a window of events. The encryption engine 108 also may be configured to modify a set of queries run against incoming events. In some implementations, the event sources and the engine processing the events may be distributed. Examples of CEP processing scenarios include the correlation of incoming security alerts and the processing of radio frequency identity (RFID) events. For example, in the correlation of incoming security alerts, the event sources may include local networks in one administrative domain connected over the Internet to a central correlation agent. In these example scenarios, the events sources typically desire to maintain the secrecy and privacy of their events. The encryption scheme of Equation (1) may be utilized to encrypt the data from the event sources to maintain their secrecy and privacy.

The encryption scheme of Equation (1) E(x) is order-preserving. The fact that E(x) is order preserving may be proven by the following Theorem. Assume x₁<x₂. It may be written:

E(x₁)=ax₁+H(x₁)=ax₁+b₁

E(x₂)=ax₂+H(x₂)=ax₂+b₂

From the assumptions, it may be concluded that

x₁<x₂ [symbol] a(x₂−x₁)≧a

0≦b₁,b₂<a [symbol] (b₁−b₂)>−a

The difference between the ciphertexts may be computed

E(x₂)−E(x₁)=a(x₂−x₁)+(b₁−b₂)>0

E(x₁)<E(x₂)

Equivalently for x₁>x₂. E(x) is a deterministic function and therefore x₁=x₂ [symbol] E(x₁)=E(x₂).

Commutation may now be considered. Let E_{A}(x)=a_{A}+H_{A}(x) and E_{B}(x)=a_{B}+H_{B}(x) be two different instances of the encryption scheme—one for Alice and one for Bob—using different keys and cryptographic hash functions. The encryption scheme is commutative, except in case of equality, since

E_{B}(E_{A}(x))≠E_{A}(E_{B}(x))(w.h.p.)

Otherwise, except for equality, the order is fully preserved under inequality. This property may be referred to as order-preserving.

As shown in the Theorem in the paragraphs above, the encryption scheme is order-preserving. It also may be shown by the following Theorem that the encryption scheme E(x) is order-preserving for inequality under commutative composition. Assuming x₁<x₂ then it may be written

E_{A}(x₁)=a_{A}x₁+H_{A}(x₁)

E_{B}(x₂)=a_{B}x₂+H_{B}(x₂)

The ciphertexts may be switched and written as

E_{B}(E_{A}(x₁))=a_{B}(a_{A}x₁+H_{A}(x₁))+H_{B}(E_{A}(x₁))

E_{A}(E_{B}(x₂))=a_{A}(a_{B}x₂+H_{B}(x₂))+H_{A}(E_{B}(x₂))

From the assumptions, it may be concluded that

x₁<x₂ [symbol] a_{A}a_{B}(x₂−x₁)≧a_{A}a_{B}

H_{A}(x)<a_{A} [symbol] 0≦H_{B}(x) [symbol] a_{A}H_{B}(x₂)−a_{B}H_{A}(x₁)≧−(a_{A}−1)a_{B}

0≦H_{A}(x) [symbol] H_{B}(x)<a_{B} [symbol] H_{A}(E_{B}(x₂))−H_{B}(E_{A}(x₁))>−a_{B}

Again, the difference between the (commuted) ciphertexts may be computed as

E_{A}(E_{B}(x₂))−E_{B}(E_{A}(x₁))=a_{A}a_{B}(x₂−x₁)+a_{A}H_{B}(x₂)−a_{B}H_{A}(x₁)+H_{A}(E_{B}(x₂))−H_{B}(E_{A}(x₁))>0

E_{B}(E_{A}(x₁))<E_{A}(E_{B}(x₂))

Equivalently for x₁>x₂. This ends the theorem to show that the encryption scheme is order-preserving under commutative composition.

One exemplary implementation of the encryption scheme may be to hide the plain text produced by different event sources. The event sources may be configured to report the events to a CEP engine (e.g., encryption engine 108) and the event sources may desire to keep the plain text hidden from the CEP engine. Yet, at the same time, the CEP engine may need to perform operations and process the events. As discussed above, it is likely that the event sources and the CEP engine are distributed.

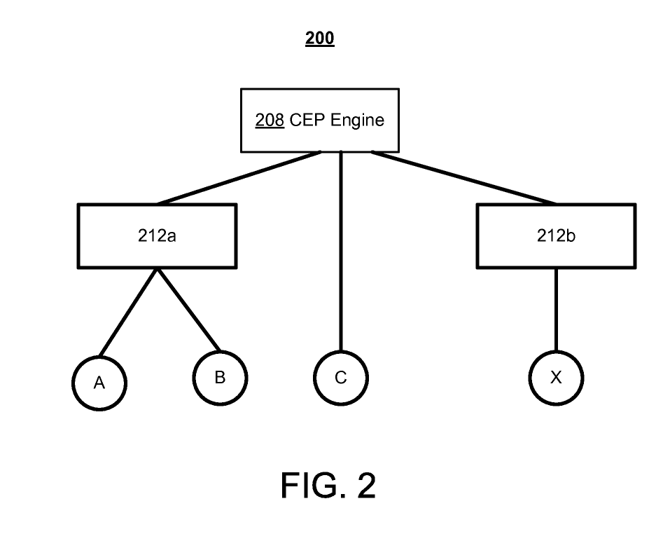

Referring to FIG. 2, an exemplary block diagram of a distributed system 200 of event sources and a CEP engine is illustrated. System 200 illustrates event sources A, B, C through X. The event sources may produce events for reporting to the CEP engine 208 for processing and analysis. The events may be communicated directly to the CEP engine 208, as is illustrated in the case of event source C. In some instances, the events may be communicated through one or more intermediate nodes, such as through intermediate nodes 212a and 212b.

As discussed above, one example scenario may include the reporting of security events for correlation at the CEP engine 208. The event sources A, B, C through X may communicate various security alerts to the CEP engine 208 for correlation and processing. The events may be communicated directly to the CEP engine 208, as in the case of event source C, or may be communicated through intermediate nodes 212a and 212b, as in the case of event sources A, B and X. Each of the event sources A, B, C and X may be configured to encrypt the plain text event data such that cipher text is communicated to the CEP engine 208 instead of plain text. In this manner, each of the event sources A, B, C and X may include a device for encryption such as device 100 of FIG. 1.

Similarly, the intermediate nodes 212a and 212b and the CEP engine 208 may include one or more devices to encrypt plain text or to perform any re-encryption as may be necessary. As such, each of the intermediate nodes 212a and 212b and the CEP engine 208 may include a device 100 of FIG. 1 to encrypt plain text. The CEP engine 208 also may be configured to perform operations on the cipher text.

In one exemplary implementation, the encryption scheme of Equation (1) may be a threshold encryption scheme where distributed event sources map to the same encryption key a. In this manner, the encryption key may be distributed among the multiple event sources (e.g., event sources A, B, C through X of FIG. 2). Assuming a composite of t large primes, the following solution maps operations to a finite field.

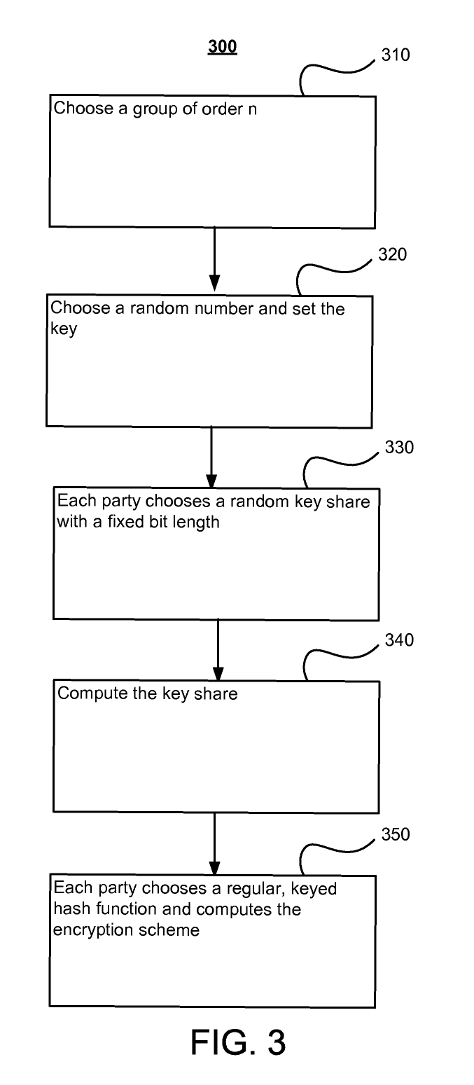

Referring to FIG. 3, a process 300 for mapping multiple event sources to a same encryption key is illustrated. A group Gₙ of order n where ∀x.E(x)<n holds may be chosen (310). The arithmetic operations are performed in Gₙ unless otherwise noted. Let Xᵢε{X₁, . . . , Xₜ} be the parties that will share the encryption key, i.e. a path in a tree from an event source to the CEP engine, such as shown in FIG. 2. A random number r (0≦r<2^{k}) may be uniformly chosen and set the key a=2^{k}+r, such that the bit length of a is always k+1(320). Each party Xᵢ(1<i≦t) similarly chooses a random key share aᵢ>0 with fixed bit length κ (330). The key share a₁ of X₁ is computed (340) as

$${a}_{1} = a {\prod }_{i = 2}^{t} {a}_{i}^{- 1}$$

The entropy of a₁ is at least k−(t−1)κ bits. Each Xᵢ(1≦i≦t) also chooses a regular, keyed, lᵢ-bit hash function Hᵢ(x) where

lᵢ=k−i−(t−i)κ

The bit lengths of the hash functions are increasing from X₁ to Xₜ, i.e.

i>j [symbol] lᵢ>lⱼ

X₁ computes E₁(x)=a₁x+H₁(x) (350). The encryption in the threshold setting then iteratively proceeds as

Eᵢ(x)=aᵢEᵢ₋₁(x)+Hᵢ(Eᵢ₋₁(x))(1<i≦t)

Thus, the encryption function is written as

Eₜ(x)=ax+b.

The above process 300 may be proven by the following theorem. If Eₜ(x)=ax+b as defined above, then b<a.

Proof. For our recursive notation we define E₀(x)=x.

$$\begin{matrix}{E}_{t} ( x ) = {a}_{t} {E}_{t - 1} ( x ) + {H}_{t} ( {E}_{t - 1} ( x ) ) \\ = {\prod }_{j = 1}^{t} {a}_{j} x + {\sum }_{j = 2}^{t} ( ( {\prod }_{i = j}^{t} {a}_{i} ) {H}_{j - 1} ( {E}_{j - 2} ( x ) ) ) + {H}_{t} ( {E}_{t - 1} ( x ) ) \\ = ax + {\sum }_{j = 2}^{t} {β}_{j} + {β}_{t + 1} \\ = ax + b\end{matrix}$$

The random summand b consists of t summands and a bound may be provided for each one. First, the factors of βⱼ may be considered.

aᵢ<2^{κ}

Hⱼ₋₁(x)<2^{k-(j-1)-(t-(j-1))κ}

The product has a maximum bit length of the bit length of the hash function Hⱼ₋₁(x) plus t−j+1 times κ from the subsequent multiplications by the key shares.

βⱼ<2^{(t-(j-1))κ+k-(j-1)-(t-(j-1)κ}=2^{k+1-j}

The maximum bit length of βₜ₊₁ is lₜ=k−t:

βₜ₊₁<2^{k-t}

The random summand b consists of t summands with maximum bit lengths from k−t to k−1. The maximum bit length of the sum b is therefore k.

$${β}_{j} < {2}^{k + 1 - j} ( 2 \leq j \leq t + 1 ) ⇒ b = {\sum }_{j = 2}^{t + 1} {β}_{j} < {2}^{k}$$

The key a has bit length k+1 and consequently a≧2^{k}. It follows that b<a.

The corollary to the theorem is that Eₜ(x) is order-preserving.

A protocol for computing the encryption keys in a threshold setting follows. In homomorphic encryption, an operation on ciphertexts produces a ciphertext of the result of a homomorphic operation on the plaintexts. In particular, the homomorphic operation may be addition in group Gₙ. Different encryption systems may be used for this. In one exemplary implementation, Paillier's efficient encryption system may be used. Paillier's encryption system includes a public-key and is semantically secure, i.e. its ciphertexts are indistinguishable in a chosen plaintext attack (IND-CPA). Let E_{X}(x) denote the encryption of x with X's public key and D_{X}( ) the corresponding decryption with X's private key, then Paillier's encryption system has the following property:

D_{X}(E_{X}(x)·E_{X}(y))=x+y

With simple arithmetic, the following property can be derived

D_{X}(E_{X}(x)^{y})=x·y

A t-out-of-n threshold variant of Paillier's encryption system has been described by Damgård and Jurik. Semantically secure encryption systems may be randomized and there is a simple rerandomization operation for a ciphertext: E′_{X}(x)=E_{X}(x)E_{X}(0)=E_{X}(x+0). For the two ciphertexts E_{X}(x) and E′_{X}(x) the indistinguishability property holds, i.e. no one without the private key can determine whether they have the same plaintext.

In one exemplary implementation, it is desirable to distribute the key shares such that no party Xᵢ learns anything about the key share of another party Xⱼ(i≠j) and no attacker controlling less than t parties can learn the key a. It is desirable to distribute the key shares without a trusted dealer and without resorting to general secure computation. For instance, referring back to FIG. 2, it is desirable that event source A not learn about the key share of event sources B, C and X. Also, it is desirable that event source B not learn about the key share of event sources A, C and X and so forth.

Assume all parties Xᵢ have a private key share in Damgård and Jurik's homomorphic encryption system using a threshold t (i.e. t-out-of-t). The public key (which entails the group Gₙ) is known to everyone, such that all participants can perform encryption E_{X}( ).

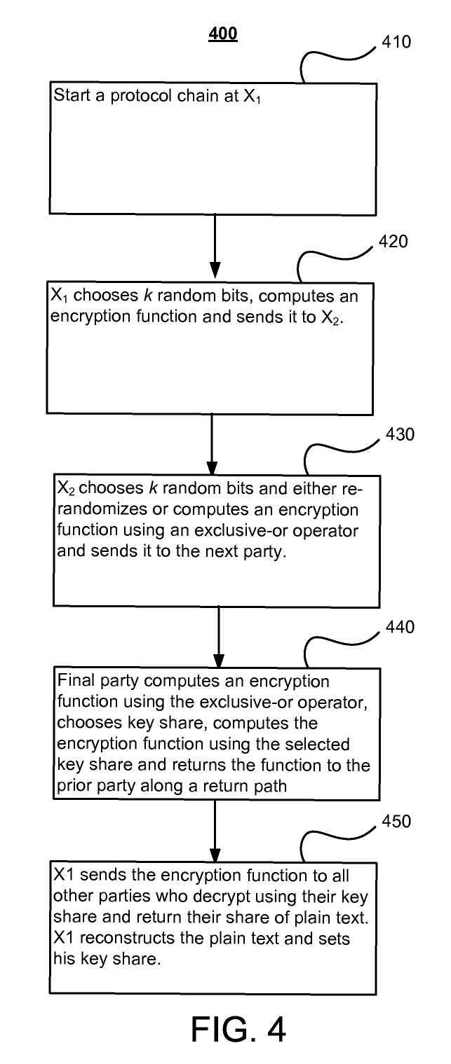

Referring to FIG. 4, an exemplary flowchart illustrates a process 400 to distribute key shares. A protocol chain is started at X₁(410). X₁ uniformly chooses k random bits r_{1,i}(0≦i<k). He sends E_{X}(r_{1,i}) to X₂(420).

X₂ uniformly chooses k random bits r_{2,i}(0≦i<k). Let ⊕ denote the “exclusive-or” operator. If r_{2,i}=0, he re-randomizes

E_{X}(s_{2,i})=E_{X}(r_{1,i})E_{X}(0)

If r_{2,i}=1, he computes

E_{X}(s_{2,i})=(E_{X}(r_{1,i})E_{X}(−1))⁻¹=E_{X}(−(r_{1,i}−1))

Note that E_{X}(s_{2,i})=E_{X}(r_{1,i}⊕r_{2,i}). He forwards E_{X}(s_{2,i}) to X₃(430).

Similarly each party Xⱼ(2<j≦t) computes

E_{X}(s_{j,i})=E_{X}(s_{j-1,i}⊕r_{j,i})

This proceeds until Xₜ has finished the exclusive-or operation on the ciphertexts and computed E_{X}(s_{t,i}). Then Xₜ computes

$${E}_{X} ( a ) = {\prod }_{i = 1}^{k} {{E}_{X} ( {s}_{t , i} )}^{{2}^{i}} = {E}_{X} ( {\sum }_{i = 1}^{k} {2}^{i} {s}_{t , i} )$$

Xₜ chooses his key share aₜ (bit length κ). He computes

E_{X}(αₜ)=E_{X}(a)^{a}^{ₜ}^{^{−1}}=E_{X}(aaₜ⁻¹)

and returns E_{X}(αₜ) to Xₜ₋₁.

In the same way each party Xⱼ (1<j<t) chooses aⱼ and returns

E_{X}(αⱼ)=E_{X}(αⱼ₊₁aⱼ⁻)

This return path proceeds until X₁ has obtained E_{X}(α₂). X₁ sends E_{X}(α₂) to all other parties Xᵢ (1<i≦t) who decrypt using their key share and return their share of the plaintext α₂(440). X₁ reconstructs the plaintext and sets his key share a₁=α₂(450).

This protocol is secure in the semi-honest model and may be secure in the malicious model using a general compiler.

In one exemplary implementation, the CEP engine (e.g., CEP engine 208 of FIG. 2) may desire to compare the events received from the event sources against one or more constants. A protocol for blind encryption, i.e. encryption without knowing the plaintext may be used. Blind encryption can be useful if the CEP engine wants to compare the events to constants, but does not want to disclose these constants.

In one exemplary implementation, Pohlig-Hellman encryption may be used as at least part of the blind encryption scheme. Pohlig-Hellman encryption is a symmetric, deterministic encryption scheme in public group Gₚ of prime order p. The encryption key is a uniformly chosen random number e (0≦e<p−1). Given a plaintext x the ciphertext is computed as

E(x)=x^{e}(mod p)

Decryption can be performed by exponentiation with the multiplicative inverse of e.

In one exemplary implementation, Pohlig-Hellman encryption may be used as the keyed, cryptographic hashing scheme. When Xᵢ chooses Hᵢ( ), he chooses a prime p with bit length lᵢ which he makes public and a random e which he keeps secret.

Let G_{S} and G_{T} be two groups of order p. A computable, non-degenerate bilinear map may be used ê: G_{S}×G_{S}→G_{T} for which the Decisional Bilinear Diffie-Hellman Problem (BDDH) is assumed to be hard. Modified Weil or Tate pairings on supersingular elliptic curves are examples of such maps. A bilinear map satisfies the following three properties:

Bilinear: for g,hεG_{S} and for a,b, bilinearity ê(g^{a},h^{b})=ê(g,h)^{ab} holds

Non-degenerate: ê(g,g)≠1 is a generator of G_{T}

Computable: there exists an efficient algorithm to compute ê(g,h) for all g,hεG_{S}

It is assumed that an efficiently computable, linear map ƒ: G_{T} [symbol] Gₚ exist, such that the output of the bilinear map in the Pohlig-Hellman encryption may be used.

In this manner, the blind encryption protocol may be as follows. Assume Alice has a plaintext x and Bob has an instance of the encryption scheme E( ). Alice wants to obtain E(x) without revealing x to Bob. Bob's parameters of E( ) are a, p and e. He chooses a random generator g in G_{S} and publishes ê( )(which implies G_{S} and G_{T}), ƒ( ), g and g^{e}.

Alice chooses a private, public key pair in Paillier's homomorphic encryption system with a plaintext group Gₙ of order n where ∀x.E(x)<n holds. She publishes the public key, such that Bob can perform encryption E_{A}( ). Alice uniformly chooses a random element r in G_{S}. She sends to Bob

ρ=ƒ(\hat{e}(g,r))x(mod p)

σ=E_{A}(ƒ(\hat{e}(g^{e},r))x)

Bob computes

E_{A}(τ)=E_{A}(ρ^{e}(mod p))σ^{a}=E_{A}(ƒ(\hat{e}(g^{e},r))(ax+H(x))

and returns it to Alice. Alice decrypts the message and can compute

E(x)=ƒ(\hat{e}(g^{e},r))⁻¹τ

In order to use the protocol in the threshold setting, e.g. for Xₜ obtaining Eₜ(x), Xₜ plays the role of Alice in the protocol above. He sequentially interacts with Xᵢ (1≦i<t) using Eᵢ₋₁(x) as input and obtaining Eᵢ(x) as output.

As discussed above, one feature of the encryption scheme is to hide the plain text produced by the event sources from the CEP engine. One aspect includes assessing the security of the encryption scheme.

First, a process for evaluating the security begins with a key recovery attack from known plain texts so that the necessary bit length of a key can be determined. With this bit length in mind, the leakage of plaintexts in a ciphertext only attack is measured. Finally, the commutative, order-preserving encryption scheme is benchmarked against the best possible order-preserving encryption in a chosen plain text attack.

An information-theoretic notion of security may be used. Both cipher text-only attacks and known plain text attacks are considered. First, note that the bit length k of the key a and the plaintext x bound the bit length of the ciphertext y=E(x). We denote |x|=┌log₂x┐ the bit length of a variable x.

k+|x|−1≦|y|≦k+|x|

Since k is a public parameter, y leaks the bit length of x. Assume that x can be encoded using m bits. In the final encoding x′ used for encryption, the m-th bit is set x′=x+2^{m}, such that it has a fixed bit length of m+1.

In a known plaintext attack, the attacker is given plain text and corresponding cipher text pairs. It is assumed the goal of the attacker is to infer the key a, since if the attacker is then given a ciphertext y for which he does not know the plaintext x, he can decipher y by computing

$$x = ⌊ \frac{y}{a} ⌋ .$$

If the attacker's uncertainty, i.e. entropy, of a is equal (or larger) to his uncertainty of x, the encryption scheme is said to be secure. Note that the attacker can always reduce the entropy of x using known plain texts and the order of their corresponding cipher texts. One should carefully limit the known plain texts, since n adaptively chosen known plain texts may reveal n bits and n non-adaptively chosen known plain texts reveal log₂(n+1) bits of x on average.

In the following, the entropy of the key a is considered. Let l be the bit length of the random summand b. Recall that k>l. A lower bound for l may be computed, such that the entropy of a is equal to the entropy of x.

This choice of remaining key entropy is motivated by the observation that a single cipher text can hide at most a single plain text, even if the entropy of the key is much larger. Nevertheless, security conscious users may fix a security parameter κ for the key a and simply add that to the bit length l of the random summand. The remaining entropy of a is then the entropy of x plus 2^{κ}.

Given a pair y, x one can compute a lower and upper bound yₘᵢₙ and yₘₐₓ of ax, i.e. the ciphertext without the random summand.

yₘᵢₙ=y−2^{l}

yₘₐₓ=y

Then one compute a lower and upper bound aₘᵢₙ and aₘₐₓ, respectively, of a.

$${a}_{min} = ⌈ \frac{{y}_{min}}{x} ⌉$$

$${a}_{max} = ⌈ \frac{{y}_{max}}{x} ⌉$$

Given a number of pairs yᵢ, xᵢ the expected value of the number of remaining possible a can be computed. In extreme cases of the random summands, such that one bᵢ is close to the minimum (0) and another bᵢ is close to the maximum (2^{l}), the adversary can infer a precisely. Nevertheless, on average the expected value can provide sufficient security.

All slopes a must pass through the origin. Let E(min(bᵢ)) and E(max(bᵢ)) be the expected value of the minimum and the maximum of the random summands. Then, the difference between the expected value of the upper and lower bounds can be computed as the difference between the minimum summand (for the upper bound) and maximum summand minus the uncertainty (for the lower bound). We assume the worst case where the upper bound is on the right of the x-axis (x=2^{m+1}−1) and the lower bound is on the left side of the x-axis (x=2^{m}). The difference d is then

$$d \geq \frac{E ( min ( b ) )}{{2}^{m + 1} - 1} + \frac{{2}^{l} - E ( max ( b ) )}{{2}^{m}} \qquad ( 3 )$$

Given n samples from a uniform distribution and a maximum observed value max, one can estimate the upper bound u of the uniform distribution as

$$u = \frac{n + 1}{n} max - 1$$

In our case we are interested in estimating max given u=2^{l} and n=2^{m}.

$$E ( max ( b ) ) = \frac{{2}^{m} ( {2}^{l} + 1 )}{{2}^{m} + 1}$$

Similarly the observed minimum can be estimated as

$$E ( min ( b ) ) = u - E ( max ( b ) ) = \frac{{2}^{l} - {2}^{m}}{{2}^{m} + 1}$$

If we insert these into Equation 3 we obtain

$$d \geq \frac{\frac{{2}^{l} - {2}^{m}}{{2}^{m} + 1}}{{2}^{m + 1} - 1} - \frac{\frac{{2}^{m} ( {2}^{l} + 1 )}{{2}^{m} + 1} - {2}^{l}}{{2}^{m}}$$

According to the security definition, it is desirable for the difference to be larger than the domain size of the plaintext.

$$d \geq {2}^{m}$$

$${2}^{l} \geq \frac{{2}^{4 m + 1} + {2}^{3 m} - {2}^{2 m} - {2}^{m}}{{2}^{m + 2} + 1}$$

$$l \geq 3 m$$

Thus, in one exemplary implementation, the bit length l of the cryptographic hash function should be chosen three times as long as the plain text bit length m in order to expect to hide a plain text against a known plain text attack even in case of code known entirely to the adversary. The bit length k of the key should be larger than l, but the length of excess does not improve security, such that it is sufficient to set k=l+1. Even though the attacker has exponentially many plain text, cipher text pairs at his disposal, the necessary key bit length remains on the same order as the plain text bit length (and is not exponential as one might expect).

Although a can be estimated using maximum likelihood as

$$\frac{{\sum }_{i = 1}^{n} \frac{{y}_{i}}{{y}_{i}}}{n} ,$$

entropy is not impacted. Every possible a in the range of expected size d is equally likely, since every a is a possible key for every known plaintext pair.

In a threshold setting the minimum random summand bit length minᵢ(lᵢ)=l₁ should be chosen three times the plain text bit length in order to achieve a successful hiding at all stages.

For modern encryption schemes a set of “standardized” games exists which can be used to prove security. One game is IND-CPA which proves for randomized, public-key encryption schemes indistinguishability of two cipher text. In a very abbreviated form, an adversary chooses two plain texts and the challenger encrypts one in his encryption scheme. The adversary should not be able to tell which one was encrypted better than by guessing (within a margin of error negligible in the security parameter). In case of deterministic encryption, the adversary may not have encrypted any of the plain texts before.

So, the following game IND-CPA-OPE may be defined for order-preserving, symmetric encryption:

Phase I: The adversary A may use an oracle for encrypting any plain text or decrypting any cipher text.

The Challenge: The adversary A hands two plain texts t₀ and t₁=t₀+1 to the challenger, such that A has neither queried E(t₀) nor E(t₁) so far. The challenger flips a bit bε{0,1} and gives E(t_{b}) to the adversary.

Phase II: The adversary A may use an oracle for encrypting any plain text t or decrypting any ciphertext E(t), as long as t≠t₀ and t≠t₁.

Guess: The adversary outputs a guess b^{å} for b.

Let Pr[IND-CPA-OPE_{A}] be the probability the attacker wins the game. Ideally this probability would be ½, but the information leaked by the order-preservation helps in winning the game.

The best strategy for the adversary is to encrypt the plain texts t₀−1 and t₁+1 in phase I. For his guess, he measures their distance to the challenge and guesses the closer one, i.e. he outputs 0 if

$$E ( {t}_{b} ) < ⌊ \frac{E ( {t}_{1} + 1 ) - E ( {t}_{0} - 1 )}{2} ⌉ + E ( {t}_{0} - 1 )$$

and 1 otherwise. The probability may be analyzed using the commutative order-preserving encryption scheme that the attacker guesses wrong, i.e. outputs 0 if b=1 or 1 if b=0.

As discussed above, plain text may be encrypted using the COPE scheme. The payload remains confidential even in a distributed environment. The key may be distributed over multiple parties arranged in a tree from the event source to the CEP engine. A distributed key reduces the consequences of break-ins and accidental leakages as well as preventing intentional disclosure. In the COPE scheme, the basic idea is to multiply by a constant, secret key and perturb the remainder by adding a smaller pseudo-random number.

Implementations of the various techniques described herein may be implemented in digital electronic circuitry, or in computer hardware, firmware, software, or in combinations of them. Implementations may be implemented as a computer program product, i.e., a computer program tangibly embodied in a non-transitory machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method including executing instructions recorded on a non-transitory computer-readable storage media using at least one processor, the method comprising:
encrypting data using a commutative order-preserving encryption scheme.

2. The method as in claim 1 wherein the commutative order-preserving encryption scheme comprises a unique fixed key and a regular keyed cryptographic hash function, wherein the cryptographic hash function comprises a domain greater than the unique fixed key.

3. The method as in claim 2 wherein a bit length of the cryptographic hash function is at least three times as long as a bit length of the data.

4. The method as in claim 2 wherein the unique fixed key is distributed in multiple portions among multiple parties.

5. The method as in claim 2 wherein the unique fixed key is distributed in multiple portions among multiple parties in a tree format from an event source to an event processing engine.

6. The method as in claim 1 wherein the commutative order-preserving encryption scheme is represented by an encryption function
E(x)=ax+H(x)=ax+b
wherein
E(x) is the encryption function,
a is a unique fixed key,
H(x) is a regular keyed cryptographic hash function
x is plaintext, and
b is a random summand.

7. The method as in claim 1 further comprising using the commutative order-preserving encryption scheme as part of a blind encryption protocol.

8. A recordable storage medium having recorded and stored thereon instructions that, when executed, cause at least one processor to perform the action of:
encrypting data using a commutative order-preserving encryption scheme.

9. The recordable storage medium of claim 8 wherein the commutative order-preserving encryption scheme comprises a unique fixed key and a regular keyed cryptographic hash function, wherein the cryptographic hash function comprises a domain greater than the unique fixed key.

10. The recordable storage medium of claim 9 wherein a bit length of the cryptographic hash function is at least three times as long as a bit length of the data.

11. The recordable storage medium of claim 9 wherein the unique fixed key is distributed in multiple portions among multiple parties.

12. The recordable storage medium of claim 9 wherein the unique fixed key is distributed in multiple portions among multiple parties in a tree format from an event source to an event processing engine.

13. The recordable storage medium of claim 8 wherein the commutative order-preserving encryption scheme is represented by an encryption function
E(x)=ax+H(x)=ax+b
wherein
E(x) is the encryption function,
a is a unique fixed key,
H(x) is a regular keyed cryptographic hash function
x is plaintext, and
b is a random summand.

14. The recordable storage medium of claim 8 further comprising instructions that, when executed, cause at least one processor to perform the action of using the commutative order-preserving encryption scheme as part of a blind encryption protocol.

15. A system for encrypting date, the system comprising:
a processor that is arranged and configured to encrypt data using a commutative order-preserving encryption scheme.

16. The system of claim 15 wherein the commutative order-preserving encryption scheme comprises a unique fixed key and a regular keyed cryptographic hash function, wherein the cryptographic hash function comprises a domain greater than the unique fixed key.

17. The system of claim 16 wherein a bit length of the cryptographic hash function is at least three times as long as a bit length of the data.

18. The system of claim 16 wherein the unique fixed key is distributed in multiple portions among multiple parties.

19. The system of claim 16 wherein the unique fixed key is distributed in multiple portions among multiple parties in a tree format from an event source to an event processing engine.

20. The system of claim 16 wherein the commutative order-preserving encryption scheme is represented by an encryption function
E(x)=ax+H(x)=ax+b
wherein
E(x) is the encryption function,
a is a unique fixed key,
H(x) is a regular keyed cryptographic hash function
x is plaintext, and
b is a random summand.
